(19) United States
(12) Patent Application Publication
(10) Pub. No.: US 2008/0017292 A1
(43) Pub. Date: Jan. 24, 2008

(54) Sterile drape and agitator for making surgical slush

(75) Inventors: Jeffery B. Gammons, Loudon, TN (US); Clifford E. Gammons, Loudon, TN (US)

Correspondence Address: KNOX PATENTS, P.O. BOX 30034, KNOXVILLE, TN, 37930-0034, US

(73) Assignee: ADROIT DEVELOPMENT, INC., Loudon, TN (US)

(21) Appl. No.: 11/459,625

(22) Filed: Jul. 24, 2006

(51) Int. Cl. B44C 3/12; C09J 5/06

(52) U.S. Cl. 156/63; 156/321

(57) ABSTRACT

A sterile drape and agitator fused together, without an adhesive or solvent, for making surgical slush and an apparatus for manufacturing such a combination. A die, at a specified temperature, is forced against a drape and an agitator with a specified force for a specified time to form a fused area that has a shear strength that is not substantially reduced from the tensile strength of the drape itself. Additionally, the drape adjacent the fused area is not substantially weakened by the fusing of the drape to the agitator. In one embodiment, a machine for fusing the drape and agitator together is disclosed, the machine having a cylinder with a piston for forcing a die against the drape and the agitator, which is mounted on a fixed base.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a sterile drape and agitator for making surgical slush. More particularly, this invention pertains to a sterile drape attached to an agitator by a heat fusing process.

2. Description of the Related Art

Many times materials are selected for the particular properties they exhibit during operation without any thought of fabrication and manufacturing. For example, the medical profession performs transplants and other surgeries in which a sterile slush solution is used. The slush is made by lowing the temperature of a saline solution in a refrigerated device that typically includes means for dislodging the congealed sterile slush solution from the sides of a slush basin. One such device is disclosed in U.S. Pat. No. 5,457,962, issued to Faries, Jr., et al., on Oct. 17, 1995, titled “Sterile drape for use in making surgical slush,” which discloses a device used for producing and collecting sterile surgical slush. The device includes a disk 19 with an attached sterile drape 17 that is used in a refrigerated basin 11. The disk 19 is moved repeatedly up and down and slush forms on the drape 17 adjacent the side walls and is prevented from solidifying into ice by the reciprocating movement of the disk 19. The patent states that the drape 17 is bonded to the disk 19 “by adhesive, welding, or the like,” but does not provide any details how such bonding is accomplished.

U.S. Pat. No. 5,502,980, issued to Faries, Jr., et al., on Apr. 2, 1996, titled “Sterile drape for use in making surgical slush,” discloses a device similar to that of the '962 patent. The preferred method of attaching the drape 17 to the disk 19 is “by means of a layer of adhesive substance 22.” Although the patent states that other means of attaching the drape 17 to the disk 19 are possible, the patent does not disclose any details for making such a bond, nor does the patent disclose the characteristics of such a bond. Various other patents disclose slush making machines with a disk agitator and a drape. However, the method of attaching the drape to the disk is typically not disclosed.

The sterile drape material must be impervious to the solution used to make the slush and must remain flexible at the temperature used to make the slush. The drape material must also have sufficient tensile strength to resist tearing and puncturing during use. It is desirable for the material of the sterile drape to be such that ice does not readily adhere to it during slush formation. Further, the reciprocating disk must be sufficiently rigid to support the volume of surgical slush above the disk without the disk breaking or excessively bending or flexing, which could lead to stress failure of the disk.

Typically, the drape material is a urethane sheet and the disk material is polycarbonate. It is known to use an ultraviolet light cured adhesive to bond the dissimilar materials of the drape and the disk; however, the resulting bond is typically weaker than either material. Such an adhesive bond is known to sometimes fail by having the sterile drape pull away from the disk during use. In other words, the shear strength of the adhesive bond is substantially less than the tensile strength of the sheet.

Attempts have been made to weld a sheet of polyurethane to a polycarbonate disk, but, until now, it has not been possible to obtain an adequate bond that is easily manufactured and has suitable characteristics for use. In addition to the dissimilarities of the two materials, the relative difference in the thickness of the sheet versus the disk causes problems in welding the two. The thin sheet must be heated as must the thicker disk, but the thin sheet must not be heated so much that the sheet is damaged or weakened and the disk must be sufficiently heated to form a weld with the sheet. Because of the difference in thickness between the sheet and the disk, common failure modes for prior art welded connections include a thinning or weakening of the sheet adjacent the welded area, which results in a reduction of the tensile strength of the sheet that is often exhibited as a tearing of the sheet. An extreme case of this failure mode is when the welding process results in holes in the sheet adjacent the weld. Another failure mode is a bond that, like an adhesive bond, is weaker than either material, with failure exhibited as a separation of the sheet and disk. In this failure mode, the shear strength of the bond is substantially less than the tensile strength of the sheet.

When speaking of tensile strength, those skilled in the art recognize that tensile strength is the maximum amount of tensile stress that a material can be subjected to before failure. Yield strength, ultimate strength, and breaking strength describe various failure modes relating to tensile strength. For example, yield strength is known as the stress that a material can withstand without permanent deformation. Ultimate strength is the maximum stress that a material can withstand. Breaking strength is the point at which a material ruptures.

A long standing problem has been how to attach the drape to the disk, or agitator, such that the drape does not easily separate from the disk at the bonded area during manual handling of the drape when the drape contains a slush solution. For example, when lifting the drape to separate the drape from the sides of the basin, excessive force may be used causing the drape to separate from the disk or tear where the drape is attached to the agitator.

Another problem is how to make the bonded area strong, without subsequently weakening the drape adjacent the bonded area. It is advantageous to be able to quickly bond the dissimilar materials of the drape and disk such that the bond is as strong as, or stronger than, the material of the drape. Additionally, it is advantageous to bond the two materials without weakening the structure of either material. For example, some solvent based adhesives will attach the drape to the disk, but the solvent weakens the drape adjacent the bonded area, thereby weakening the tensile strength of the drape.

### BRIEF SUMMARY OF THE INVENTION

According to one embodiment of the present invention a sterile drape and agitator for making surgical slush and an apparatus for manufacturing such a combination is provided. The drape is bonded to the agitator by compressing the drape and agitator and applying a heated die for a specified period of time. In one embodiment, a pneumatic cylinder is actuated to apply a heated die to the drape. The cylinder applies a force to the die to press the drape against the agitator while the die transfers heat to the drape and the agitator. After a preset time, the cylinder releases the force and the die is removed from the drape. The resulting bond of the drape to the agitator has a shear strength not substantially reduced from the tensile strength of the drape. Further, at the point where the drape bonds to the agitator, the tensile strength of the drape has not been substantially reduced.

A method of fabricating a drape fused to an agitator is also disclosed. The method includes the steps of heating a die to a selected temperature before applying the die to the drape and agitator with a selected force for a selected time. The selected temperature, force, and time are controlled to create a fused connection having a shear strength substantially the same as or greater than the tensile strength of the drape. Further, the drape adjacent the fused connection has a tensile strength that is not substantially reduced from the tensile strength of the drape before fusing.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a slush stirrer showing a sterile drape and agitator;

FIG. 2 is a cross-sectional view of one embodiment of the drape and agitator;

FIG. 3 is an top view of one embodiment of the drape bonded to the agitator; and

FIG. 4 is a symbolic side view of the apparatus for bonding the drape to the agitator.

### DETAILED DESCRIPTION OF THE INVENTION

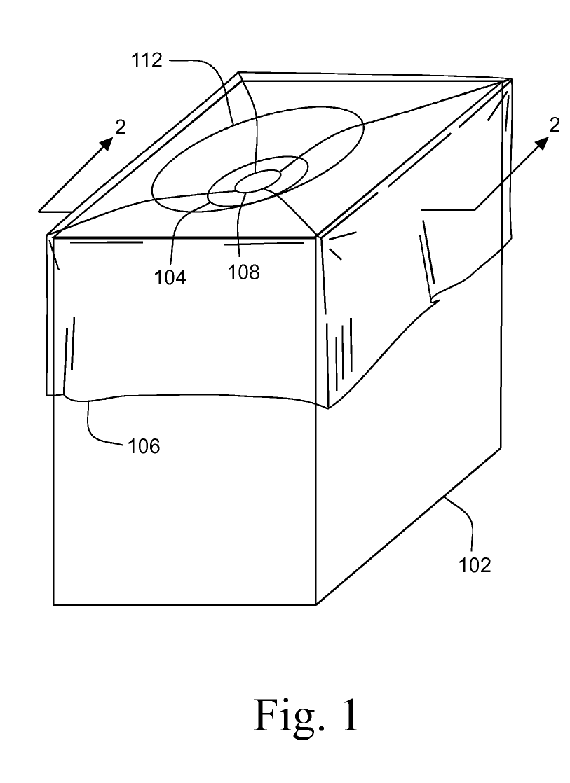

A combination of a sterile drape 106 and an agitator 104 for making surgical slush and an apparatus 400 for manufacturing such a combination is disclosed. FIG. 1 illustrates a perspective view of a slush stirrer 102 showing the sterile drape 106 and the agitator 104 within a basin 112. The slush stirrer 102 is a machine that includes a basin 112 that is refrigerated. The slush stirrer 102 may include controls and/or a warming tray (not illustrated) to assist medical workers in creating and maintaining the slush. The drape 106 is attached to the center portion, or the bonded portion, 108 of the agitator 104. The drape 106 is typically sized to extend from the agitator 104, conform to the sides of the basin 112, cover the top of the stirrer 102 and extend down the sides.

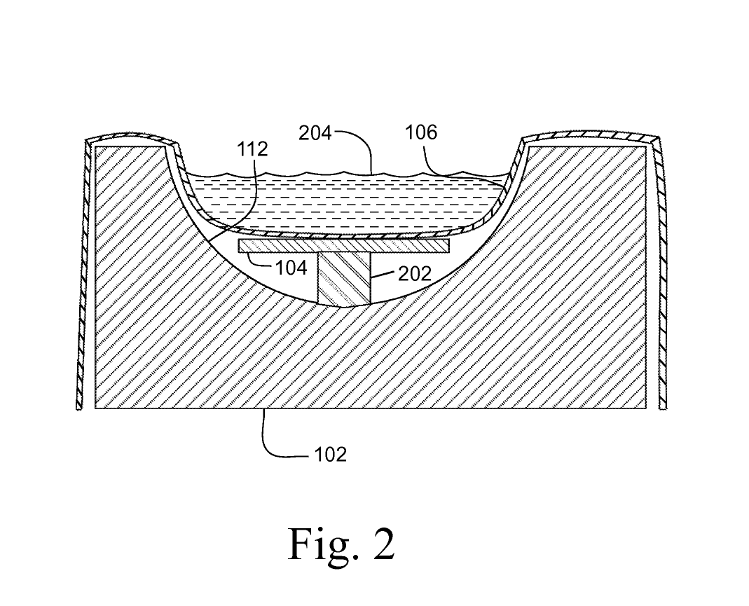

FIG. 2 illustrates a cross-sectional view of one embodiment of the drape 106 and agitator 104. The basin 112 is bowl-shaped and has an agitator shaft 202 protruding from the bottom of the basin 112. The agitator 104 attaches to the top of an agitator shaft 202 and the agitator 104 moves in concert with the agitator shaft 202. As the agitator 104 and the agitator shaft 202 reciprocate up and down, the fluid 204 contained within the basin 112 is agitated. The basin 112 is refrigerated to cool the fluid 204 to or near the freezing point of the fluid 204. The fluid 204 adjacent the walls of the basin 112 freezes first if the fluid 204 is left undisturbed. Accordingly, as the agitator 104 reciprocates, the fluid 204 is stirred such that the fluid 204 becomes slush. The temperature and amount of stirring is controlled to obtain the desired consistency of slush to meet medical needs.

The drape 106 is attached to the agitator 104 and extends along the sides of the basin 112 and over the top of the stirrer 102 and down the sides of the stirrer 102. When the agitator 104 is reciprocating up and down, the portion of the drape 106 attached to the agitator 104 and in contact with the top of the agitator 104 moves in concert with the agitator 104. Ideally, the portion of the drape 106 between the side of the agitator 104 and the walls of the basin 112 flexes as the agitator 104 reciprocates. It is desirable for the portion of the drape 106 along the side of the basin 112 to not form an air-tight seal with the basin 112 in order for air to flow between outside the basin 112 and the bottom of the basin 112 near the agitator 104. Otherwise, as the agitator 104 moves up and attempts to increase the volume under the agitator 104, a vacuum or low pressure volume will be formed, thereby sucking or pulling the drape 106 down between the bottom of the agitator 104 and the basin 112. Accordingly, the drape 106 must be stiff enough to not completely conform to the shape of the basin 112 and not form an air tight seal around the upper circumference of the basin 112.

Oftentimes during the operation of the slush stirrer 102, it is necessary for a medical practitioner to lift up on the drape 106 in order to prevent an air-tight seal forming. Also, if the refrigeration is cycled on and off, condensation may form on the inside surface of the basin 112 and then freeze, thereby adhering the drape 106 to the walls of the basin 112. Lifting the drape 106 and allowing the condensation to frost before lowering the drape 104 prevents the drape 104 from forming an air-tight seal with the walls of the basin 112. Lifting the drape 106, particularly when it holds a quantity of slush 204, applies stress to the bonded portion 108 of the drape 106/agitator 104 combination. If the person lifting the drape 106 is not careful, the drape 106 can pull away and separate from the agitator 104 if the bonded area 108 is not sufficiently strong, such as is the case when an adhesive is used to attach the drape 106 to the agitator 104. Additionally, if the drape 106 has been weakened by its attachment to the agitator 104, the drape 106 will tear, which not only contaminates the slush 204, but also allows the slush 204 to enter the basin 112 and potentially damage the agitation mechanism of the stirrer 102.

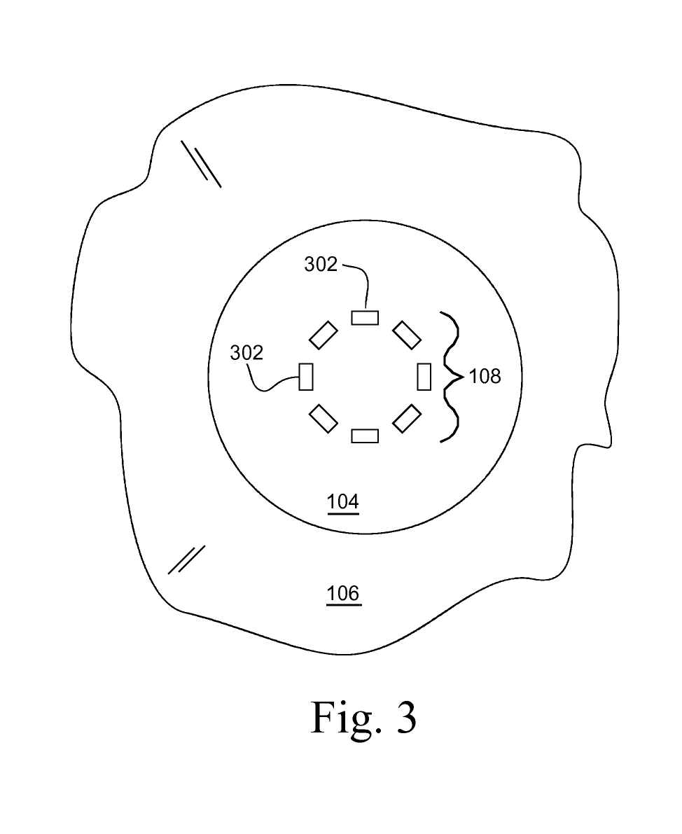

FIG. 3 illustrates a top view of one embodiment of the drape 106 bonded to the agitator 104. The bonded area 108 includes a series of heat fused areas 302 that attach the drape 106 to the agitator 104. The fused areas 302 are formed by the application of heat and pressure for a specified time. In one embodiment, the drape 106 is a clear sheet of flexible polyurethane that is very thin, approximately 1 to 10 mils, and the agitator 104 is formed of polycarbonate that is approximately 1/32 to 1/16 inch thick (approximately 30 to 60 mils). In the past, attaching polyurethane sheets to polycarbonate has proven to form unsuitable connections. That is, the connections were weak and did not have the requisite strength and durability to meet the demands of a slush stirrer 102. The apparatus and methods disclosed herein form connections between polyurethane sheets 106 and polycarbonate agitators 104 that are unexpected in that the connections have not been able to be made reliably and with the requisite characteristics before the invention herein.

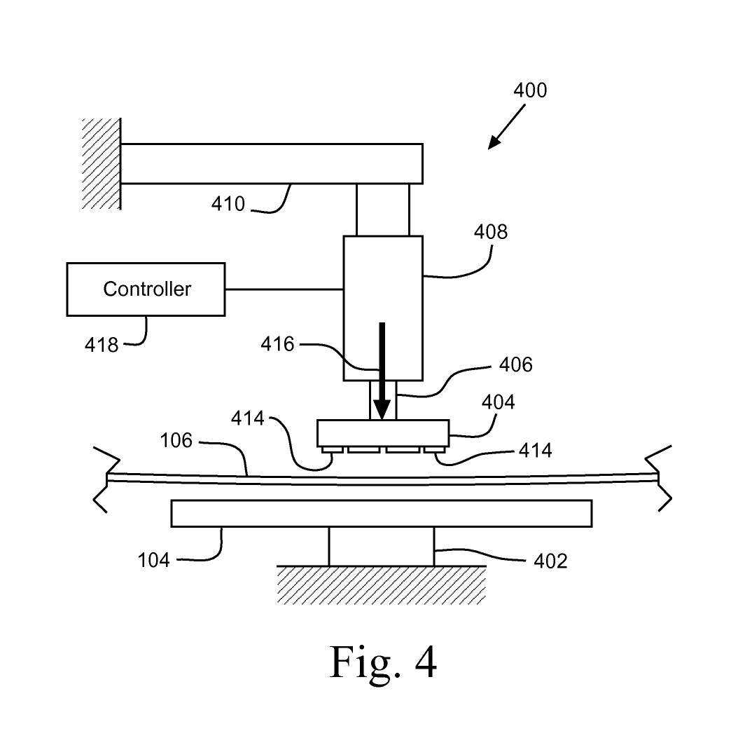

FIG. 4 illustrates a symbolic side view of the apparatus 400 for bonding the drape 106 to the agitator 104 by creating fused areas 302 on the drape 106 and agitator 104. In the illustrated embodiment, the agitator 104 is supported on a fixed base 402 with the drape 106 positioned above the agitator 104. The top of the fixed base 402 has an interface adapted to receive and support the agitator 104 in a fixed, secure position.

Above the fixed base 402 is a heated die, or stamp, 404. On one surface of the die 404, which is adjacent to the drape 106, has a raised pattern 414 that corresponds to the shape of the fused areas 302. The die 404 includes a heater that heats the raised pattern 414 to a specified temperature. The opposite end of the die 404 is attached to the piston 406 of a cylinder 408 that is supported by an arm 410. The cylinder 408 receives a pressurized fluid and the piston 406 moves linearly 416 in relation to that pressurized fluid. The movement 416 of the piston 406 is normal, or substantially perpendicular, to the plane of the top surface of the agitator 104 such that the raised surface 414 makes full contact with equal pressure over its full surface area with the drape 106 and the agitator 104 when the piston 406 is in the extended position. When the piston 406 is in the retracted position, there is sufficient clearance between the raised surface 414 of the die 404 and the drape 106 to allow the drape 106 and agitator 104 to be removed from the apparatus 400.

The arm 410 provides support to the cylinder 408 when the cylinder 408 is being actuated. In various embodiments, the arm 410 is articulated or otherwise repositionable such that the die 404 is able to be positioned or moved out of the way to aid in the placement and removal of the agitator 104 and drape 106.

The apparatus 400 includes a controller 418 that is in communication with the cylinder 408 and the heater that controls the temperature of the raised pattern 414 on the die 404. The controller 418 provides the signals that cause the cylinder 408 to actuate and move the piston 406 and attached die 404 between a first and second position. The controller 418 also maintains the temperature of the raised area 414 of the die at the selected temperature.

To create a fused, or bonded, connection 108, an agitator 104 is placed on the fixed base 402 and a drape 106 is positioned over the top surface of the agitator 104. When the cylinder 408 is actuated, the piston 406 moves down 416 in a direction normal (or perpendicular) to the plane of the drape 106 and the top surface of the agitator 104, thereby forcing the raised pattern 414 against the drape 106 and the agitator 104 with a selected pressure or force. The drape 106 and the agitator 104 are compressed between the die 404 and the fixed base 402. In various embodiments, the compression may or may not be accompanied by a reduction of thickness of the drape 106 and/or the agitator 104. The raised pattern portion 414 of the die 404 is maintained at a selected temperature, such that when the die 404 is forced against the drape 106 for a selected time at the selected pressure, the fused areas 302 are formed. In order to make the fused areas 302, three factors have to be considered: time, temperature, and pressure. Control of these three factors results in a bonded area 108 having the desired properties.

In one embodiment, the fused areas 302 have a shear strength substantially equal to or greater than the tensile strength of the drape 106 by itself. That is, by fusing the drape 106 to the agitator 104, the resulting bonded area 108 has at least substantially the same strength as the material of the drape 106. Further, the tensile strength of the boundary between the fused area 302 and the remainder of the drape 106 is not substantially reduced from the tensile strength of the material of the drape 106. In one embodiment, the temperature, time, and force are such that the area adjacent the fused area 302 on the drape 106 has a slight thinning and/or weakening such that the failure mode is for the drape 106 to rupture at or near the boundary of the fused area 302.

In one embodiment, the drape 106 is a urethane material and the agitator 104 is a polycarbonate material. In one prototype, the temperature of the raised pattern 414 on the die 404 is a nominal 450 degrees Fahrenheit, that is, the temperature ranges between 450 and 460 degrees Fahrenheit. The cylinder 408 is a pneumatic cylinder with a piston 406 having a 4 inch diameter surface subjected to 38 pounds per square inch gauge (psig) pressure upon actuation. The raised pattern 414 has a surface area of approximately 2 square inches resulting in a bonded area 108 of approximately 2 square inches. The force applied by the raised patter 414 to the drape 106 and agitator 104 is approximately 240 pounds per square inch force. The cylinder 408 is actuated for a nominal 6 seconds to fuse the drape 106 to the agitator 104. Nominal values are those values that are designated or desired, but the actual value may vary an insignificant amount from the specified nominal value.

With another prototype, the temperature of the raised pattern 414 on the die 404 is a nominal 450 degrees Fahrenheit and the cylinder 408 has a piston 406 with a 3½ inch diameter head subjected to 44 psig upon actuation. With the same raised pattern 414 surface area, the force applied to the drape 106 and agitator 104 is just over 200 pounds per square inch force.

With these prototypes, the fused areas 302 were tested to have a shear strength no less than the tensile strength of the material of the drape 106. The test was performed by holding the agitator 104 in a fixed position and applying a pulling force to the drape 106 in the plane of the top surface of the agitator 104. The material of the drape 106 was observed to deform by stretching adjacent to the boundary of the bonded area 108 followed by separation of the one section of the drape 106 from another section, typically adjacent to or near the boundary of the fused areas 302. The testing indicates that there may have been a slight thinning or weakening of the drape 106 adjacent the fused areas 302, but that the thinning or weakening was not substantial.

In another test, the agitator 104 was held in a fixed position and the drape 106 was pulled in a direction normal to the plane of the top surface of the agitator 106. This test determined the tensile strength of the fused areas 302 relative to the drape 106. The material of the drape 106 was observed to deform by stretching adjacent the boundary of the bonded area 108 followed by separation of the drape 106 from the agitator 104 at the fused areas 302. It is noted that the fused area 302 can be considered a brittle material because of the rigidity of the agitator 302 in the direction of the pull force compared to the pliable nature of the material of the drape 106. The failure mode of the fused areas 302 was separation whereas the failure mode of the drape 106 is deformation followed by rupture. This testing indicates that the tensile strength of the fused areas 302 was almost as great as the tensile strength of the material of the drape 106.

Other prototypes of the fused drape 106 and agitator 104 were made with the temperature, force, and time varied from the nominal values specified above. For example, one set of prototypes was made by varying the temperature of the die 404 greater than plus and minus 15 degrees from the nominal 450 degree Fahrenheit temperature, that is, less than 435 and greater than 465 degrees Fahrenheit. Testing of these prototypes indicated that the fused areas 302 either had reduced strength or weakened the drape 106 adjacent the fused areas 302.

From the foregoing description, it will be recognized by those skilled in the art that an apparatus 400 for fabricating an agitator 104 with an attached drape 106 for containing a slush solution 204 in a medical stirrer 102 has been provided. Also, it will be recognized by those skilled in the art that a method of fabricating an agitator 104 with an attached drape 106 for containing a slush solution 204 in a medical stirrer 102 has been provided. It will also be by those skilled in the art that an agitator 104 with an attached drape 106 for containing a slush solution 204 in a medical stirrer 102 has been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for fusing, without an adhesive or solvent, an agitator and a drape for containing a slush solution in a medical stirrer, said apparatus comprising:
a base having an interface portion for receiving and supporting an agitator, said agitator adapted for agitating the slush solution in the medical stirrer;
a cylinder having a piston, said piston movable along an axis normal to a surface of the agitator on said base;
a die having a surface for creating a fused area on a sheet and the agitator, said sheet being the drape, said piston attached to said die opposite said surface, said piston moving said die between a first position and a second position, said first position of said die being with said die immediately adjacent said base whereby said surface of said die presses said sheet and the agitator against said base with a specified force for a specified time, said second position of said die being away from said base such that the agitator and said sheet are removable from between said die and said base;
a heater in thermal contact with said surface of said die, said heater maintaining said surface at a specified temperature; and
a controller in communication with said cylinder and said die, said controller maintaining said specified force, said controller causing said cylinder to apply said force for said specified time with said surface of said die at said specified temperature when said die is in said first position whereby said surface on said die fuses said sheet to said agitator;
whereby the drape and the agitator are fused together at said fused area by said surface pressing against the drape and the agitator with said specified pressure at said specified temperature for said specified time.

2. The apparatus of claim 1 wherein said controller controls said specified force, said specified time, and said specified temperature such that said fused area has a shear strength substantially equal to a tensile strength of said sheet away from said fused area.

3. The apparatus of claim 1 wherein said controller controls said specified force, said specified time, and said specified temperature such that said fused area has a shear strength not substantially less than a tensile strength of said sheet away from said fused area.

4. The apparatus of claim 1 wherein said controller controls said specified force, said specified time, and said specified temperature such that said drape adjacent said fused area has a tensile strength less than a tensile strength of said sheet away from said fused area.

5. The apparatus of claim 1 wherein said sheet is a urethane material, said agitator is a polycarbonate material, said specified temperature is greater than 435 degrees Fahrenheit and less than 465 degrees Fahrenheit, said specified force is at least 200 pounds per square inch, and said specified time is a nominal 6 seconds.

6. The apparatus of claim 1 wherein said sheet is a urethane material, said agitator is a polycarbonate material, and said specified temperature is greater than 435 degrees Fahrenheit.

7. The apparatus of claim 6 wherein said specified temperature is less than 465 degrees Fahrenheit.

8. The apparatus of claim 6 wherein said specified force is at least 200 pounds per square inch.

9. A method for fusing, without an adhesive or solvent, an agitator and a drape for containing a slush solution in a medical stirrer, said method comprising the steps of:
a) heat a surface of a die to a specified temperature, said surface of said die for creating a fused area on the drape and the agitator, said die attached to a member movable normal to a plane defined by a surface of the agitator with the agitator mounted on a fixed base;
b) position the drape adjacent said surface of the agitator, the agitator being held in a fixed position on said fixed base;
c) press said die against the drape and the agitator with a specified force, the drape and the agitator being compressed by said die; and
d) a specified time after said step c) of pressing is initiated, remove said die from said sheet.

10. The method of claim 9 wherein said fused area after said step d) of removing has a shear strength substantially equal to a tensile strength of said sheet away from said fused area.

11. The method of claim 9 wherein said fused area after said step d) of removing has a shear strength not substantially less than a tensile strength of said sheet away from said fused area.

12. The method of claim 9 wherein the drape adjacent said fused area after said step d) of removing has an adjacent tensile strength not substantially less than an original tensile strength of the drape before said step c) of pressing.

13. The method of claim 12 wherein the drape adjacent said fused area after said step d) of removing has a tensile strength less than a tensile strength of said sheet away from said fused area.

14. The method of claim 9 wherein the drape adjacent said fused area after said step d) of removing has a tensile strength less than a tensile strength of said sheet away from said fused area.

15. The method of claim 9 wherein the drape is a urethane material and the agitator is a polycarbonate material.

16. The method of claim 9 wherein the drape is a urethane material, the agitator is a polycarbonate material, said specified temperature is greater than 435 degrees Fahrenheit and less than 465 degrees Fahrenheit, said specified force is at least 200 pounds per square inch, and said specified time is a nominal 6 seconds.

17. The method of claim 9 wherein the drape is a urethane material, the agitator is a polycarbonate material, and said specified temperature is greater than 435 degrees Fahrenheit.

18. The method of claim 17 wherein said specified force is at least 200 pounds per square inch.

19. An apparatus for containing a slush solution in a medical stirrer, said apparatus comprising:
an agitator sized to fit within a basin of the medical stirrer, said agitator adapted to couple to the medical stirrer;
a sheet of a flexible material, said sheet having a sheet thickness substantially less than a thickness of said agitator, said sheet in direct contact with said agitator at a fused area, said fused area being a thermal bond having a shear strength not substantially less than an original tensile strength of said sheet before being bonded, said sheet adjacent said fused area having an adjacent tensile strength not substantially less than said original tensile strength.

20. The apparatus of claim 19 wherein said flexible material is a urethane material and said agitator is a polycarbonate material.
